(19) United States
(12) Patent Application Publication
(10) Pub. No.: US 2019/0281915 A1
(43) Pub. Date: Sep. 19, 2019

(54) SEAMLESS WEARABLE STRUCTURE GARMENT

(71) Applicant: F.F.P. Technologies Ltd., Tel-Aviv (IL)

(72) Inventors: May LEVI, Shoham (IL); Romi FAYLO, Jaffa (IL); Noy SHAY, Herzlia (IL); Natalie EDRI, Tel-Aviv (IL); Naum NAVEH, Beit-Shearim (IL)

(73) Assignee: F.F.P. Technologies Ltd., Tel-Aviv (IL)

(21) Appl. No.: 16/318,716

(22) PCT Filed: Jul. 20, 2017
(86) PCT No.: PCT/IL2017/050822

§ 371 Date: Jan. 18, 2019

Related U.S. Application Data
(60) Provisional application No. 62/364,372, filed on Jul. 20, 2016.

(51) Int. Cl. A41H 43/04

(52) U.S. Cl. CPC A41H 43/04; B29C 45/0001

(57) ABSTRACT

A garment based of a seamless wearable structure is provided herein, wherein the structure is made by molding, spinning, dipping or spraying, and characterized by at least one attribute such as breathability, drape, stretch and recovery, dimensional stability, wash-fastness, tensile strength, tearing strength, abrasion flex and resistance, water absorbency and wrinkle recovery, which is within acceptable values according to the standards used in the garment industry.

### RELATED APPLICATION/S

This application claims the benefit of priority of U.S. Provisional Patent Application No. 62/364,372 filed 20 Jul. 2016, the contents of which are incorporated herein by reference in their entirety.

### FIELD AND BACKGROUND OF THE INVENTION

The present invention, in some embodiments thereof, relates to an article-of-clothing and fashion, and more particularly, but not exclusively, to garments based on a seamless wearable structure.

Current garment and fashion technologies produce articles of clothing in the traditional lengthy process that starts in obtaining fibrous material, either from natural sources (e.g., growing cotton or sheep), or from synthetic/artificial sources, continues through cloth/fabric production and ends with cutting and stitching. A typical traditional garment making process involves cultivating, ginning, harvesting, cleaning, blending, carding, combing, drawing, spinning, twisting and winding (yarn manufacture), looming, weaving, bleaching, coloring and dyeing, cutting and stitching, just to name some of the steps on the way of making an article of clothing.

Although modern production methods and automation are used extensively in the garment industry, these lengthy process is no longer adequate to provide and satisfy current demands in terms of flexibility and personalization. For example, this-year's fashion is typically decided-upon at least a year before to allow the manufacturers to order fabrics and have them dyed and printed, cut and sewed well ahead in order to be marketed as this-year's fashion mode.

The demand of today's dynamic garment market for up-to-date, fine and personalized yet fashionable and affordable apparel, cannot be met by today's garment industry, which is still routed in the traditional garment production methodologies and processes.

In an attempt to lower the cost, steps and lead-time of fabric production, many technologies have been developed to produce fine synthetic fibers and nonwoven fabrics. For example, methods for producing shape-retaining and/or directional stretchable nonwoven fabrics for custom made garments, are disclosed in U.S. Patent Application Publication Nos. 20140271966, 20140200527, 20130262260, 20120322333, 20120156427, 20050124957 and 20050119631, to Tamicare LTD.

Modern weaving, knitting and needling techniques have also been developed to lower the cost, steps and lead-time of fabric production. For example, U.S. Pat. Nos. 9,352,516, 8,132,431, 7,331,200, 7,299,660, 7,107,658, 6,993,939 to 6,691,535, to Karl Mayer Textilmaschinenfabrik GmbH, provide Raschel and warp-knitting methods and apparati, as well as warp-knitted textiles and needling technologies for nonwoven fabrics.

International Patent Application Publication Nos. WO 2016/055904, WO 2015/140687, WO 2014/191868, WO 2013/037654, WO 2012/093316, WO 2011/004310, WO 2010/142478, WO 2009/013773, WO 2006/072969, WO 2005/100659, WO 2004/097092, WO 2003/100147, WO 2001/048288 to Santoni S.P.A., teach various aspects and uses of circular knitting machines.

Circular knitting has been provided in numerous documents, including, for example, U.S. Pat. Nos. 9,347,156, 9,010,156, 8,726,699, 8,561,434, 8,484,998, 8,418,507, 7,900,483, 7,765,836, 6,948,342, 6,915,666, 6,848,280, 6,568,221, 6,247,335, 5,165,259, 5,070,711, 3,854,304, 3,754,416 and 3,530,686. Circular knitting lead to spin-knit machines that spin yarn from rovings that are mounted close to the machine then subsequently knit the spun yarn. This technology is aimed at shortening the fabric production process, making separate ring spinning, cleaning and rewinding steps no longer required, which lowers production costs and lower investment in machinery.

U.S. Pat. No. 6,941,775, Patent Application Publication No. 20030224685 and International Patent Application Publication No. WO 2003/087451 to Vikram Sharma, teach a tubular knit fabrics and used thereof.

U.S. Pat. Nos. 8,124,549 and 8,088,315, U.S. Patent Application Publication Nos. 20100286583, 20090036014 and 20050222320, and International Patent Application Publication Nos. WO 2007/000598, WO 2007/000599 and WO 2003/104540, and EP 1511577 to Manel Torres, teach a sprayable composition for forming a nonwoven fabric on a solid substrate, comprising fibers, binders and carriers.

3D-printing has been developing rapidly, and has been proposed for producing garments, in, for example, U.S. Patent Application Publication Nos. 20150324490 and 20160046803, U.S. Pat. No. 6,402,403 and International Patent Application Publication No. WO 2015/153400. However, this approach suffers from highly limited compatibility of the materials for truly wearable articles of clothing (stretchability, breathability, strength, drape, wash- and rub-fastness, to name a few), and from the effort, cost and time of production, regardless of the used materials, making this very promising model-making technology inappropriate for industrial production of garments.

Thus, all the abovementioned and other technologies do not provide a comprehensive solution to the production of personalized, high-end, fine, fashionable and affordable garments.

### SUMMARY OF THE INVENTION

A garment based of a seamless wearable structure is provided herein, wherein the structure is made by molding, spinning, dipping or spraying, and characterized by at least one attribute such as breathability, drape, stretch and recovery, dimensional stability, wash-fastness, tensile strength, tearing strength, abrasion flex and resistance, water absorbency and wrinkle recovery, which is within acceptable values according to the standards used in the garment industry.

According to an aspect of some embodiments of the present invention, there is provided a garment which includes a seamless wearable structure.

In some embodiment, the structure is characterized by at least one tubular portion.

In some embodiment, the structure is characterized by at least one body-part opening. In some embodiment, the structure is characterized by at least two body-part openings. In some embodiment, the structure is characterized by at least three body-part openings.

In some embodiment, the garment comprises a single seamless wearable structure. In some embodiment, the garment is a single seamless wearable structure.

In some embodiment, the structure includes at least one structural feature selected from the group consisting of appendix mounting, pattern, hole, eyelet, slit, mesh, net, thickening, bulge, protrusion, pleats, ribs, fold, crease, ridge, latch, loop, strap and any combination thereof.

In some embodiment, the appendix is selected from the group consisting of a pocket panel, a button, a zipper, a collar, a cufflink, a belt, a buckle, a hood, a glove, a sleeve and another garment.

In some embodiment, the appendix is integrally formed with the structure. In some embodiment, the appendix is attached to the structure. In some embodiment, the appendix is attached to the structure post manufacturing of the structure.

In some embodiment, the garment presented herein is selected from the group consisting of baby grow, blazer, blouse, body shaper, boot, boxers, bra, briefs, burka, camisole, cargos, catsuit, chemise, coat, corset, dungarees, glove, gown, hat, headdress, headpiece, hijab, hood, hooded pullover, jacket, jellabiya, jersey, jumper, kimono, knickers, overalls, poncho, pullover, robe, romper, shapewear, shellsuit, swimwear, tankini, thong, tights, top, trousers, trunks, T-shirt, undergarment, underpants, undershirt, vest, waistcoat and wetsuit. In some embodiment, the garment is not a headwear, a handwear or a footwear.

In some embodiment, the structure includes at least one structural region. In some embodiment, the structure includes a plurality of structural regions, each of the structural regions is individually characterized by a thickness that ranges from 0.1 to 10 mm. In some embodiment, the structure includes a plurality of structural regions, each of the structural regions is individually characterized by a mass per unit area that ranges from 50 to 400 grams per square meter.

In some embodiment, the structure is made of one type of material. In some embodiment, the structure is made of at least two types of materials. In some embodiment, the structure is made of a plurality of materials being distributed in a predetermined arrangement of portions of the structure, the portions merge into one-another in a seamless interface.

In some embodiment, the structure or any portion thereof, or each of the materials is individually characterized by at least one of:

a breathability level that ranges from 0 Ret to 20 Ret according to standard ISO 11092 (the Ret or Hohenstein test), or another industry acceptable standard for desired breathability;

a drape coefficient that ranges from 10% to 80% according to Cusick drape test, or another industry acceptable standard for desired drape;

a stretch and recovery level at 2 kg that ranges from 4% to 400% according to standard ASTM D 3107, or another industry acceptable standard for desired stretch and recovery;

a dimensional stability to laundering after 3 washes lower than 5% according to standard AATCC 135, or another industry acceptable standard for desired stretch and recovery and wash fastness;

a tensile strength of at least 10 kg according to standard ASTM D 5034, or another industry acceptable standard for desired tensile strength, such as, for example ASTM D638 or ASTM D412;

a tearing strength of at least 1 kg according to standard ASTM D 1424, or another industry acceptable standard for desired tearing strength;

an abrasion flex of no rupture or damage for at least 1000 cycles according to standard ASTM D 3885, or another industry acceptable standard for desired abrasion flex;

an abrasion resistance of no rupture to at least 10,000 cycles according to standard ASTM D 4966, or another industry acceptable standard for desired abrasion resistance;

a water absorbency under 5 seconds according to AATCC/ASTM TS-018, or another industry acceptable standard for desired water absorbency; and

a wrinkle recovery/resistance better than 2 on a scale of 1-5 according to AATCC 128/143, or another industry acceptable standard for desired wrinkle recovery/resistance.

In some embodiment, the material is selected from the group consisting of a polymer, a co-polymer, a fiber-polymer mixture, a polymeric foam, the polymer is a synthetic polymer, a naturally occurring polymer, and a mixture thereof.

In some embodiment, the structure is a single layered structure or a multi-layered structure.

In some embodiment, the structure is formed by mold casting, mold injection, spinning, dipping, spraying, painting and brushing.

In some embodiment, the structure is not a woven fabric. In some embodiment, the structure is a nonwoven fabric.

According to an aspect of some embodiments of the present invention, there is provided a method of manufacturing the garment presented herein, the method includes forming the seamless wearable structure by a process selected from the group consisting of mold casting, mold injection, spinning, dipping, spraying, painting and brushing.

In some embodiment, the method further includes, after forming the seamless wearable structure, attaching at least one appendix to the structure.

According to an aspect of some embodiments of the present invention, there is provided a mold for manufacturing the garment presented herein, the mold includes at least one mold cavity in the shape of a seamless wearable structure, and at least one sprue for letting a material precursor into the mold's cavity.

In some embodiment, the mold is characterized by at least one molding feature in its cavity, for forming at least one structural feature in the structure.

In some embodiment, the molding feature is for forming a structural feature selected from the group consisting of appendix mounting, pleat, pattern, hole, eyelet, slit, mesh, net, thickening, bulge, protrusion, pleats, ribs, fold, crease, ridge, latch, loop, strap and any combination thereof.

In some embodiment, the mold is characterized by a plurality of sprues distributed in the mold for feeding a predetermined arrangement of portions of the cavity.

In some embodiment, each of the plurality of sprues is configured individually for delivering a different and/or an identical liquid or powdered precursor of a material to form a predetermined arrangement of portions of the structure.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a schematic wireframe illustration of an exemplary garment, according to some embodiments of the present invention, showing garment 10 comprising seamless wearable structure 11, having four body-part openings, neck opening 12, arm opening 13a, arm opening 13b, and torso opening 14, wherein tubular arm portion 15 is open on one side and continues flowingly into tubular torso portion 16;

FIGS. 2A-B present schematic illustrations of an exemplary garment, according to some embodiments of the present invention, showing in FIG. 2A garment 20 comprising pleated neck opening structural region 21, pleated shoulder structural region 22, pleated underarm structural region 23, and pleated torso flank panel region 24, wherein each of the pleated structural regions confers stretchability/contractibility to that particular region of the garment, and showing in FIG. 2B garment 20 comprising sleeve folding strap 25, configured to latch on to prong 26 positioned on the shoulder, wherein sleeve 27 is shown folded and held in place by sleeve folding strap 25;

FIGS. 3A-B present an exemplary garment, according to some embodiments of the present invention, showing garment 30 having a set of holes 31 arranged so as to allow hitching pocket panel 32 (FIG. 3A), and showing garment 30 having a pocket made from pocket panel 32 (FIG. 3B);

FIGS. 4A-F present exemplary microstructures useful in making at least some portions of the garment, according to some embodiments of the present invention, wherein FIGS. 4A-B show schematic illustrations of the microstructure of some reticulated foams, FIG. 4C shows an electron micrograph of a reticulated foam, and

FIGS. 4D-F show a class of foams known as open-cell polymerized high internal phase emulsions (polyHIPEs);

FIG. 5 presents an illustration of an exemplary garment, according to some embodiments of the present invention, showing garment 50 having front-side portion 51 comprising a highly breathable material, chest portion 52 and hip region 53 being thicker for improved impact protection, underarm region 54 comprising a flexible material, neck-opening region 55 being expandable and contractible, shoulder regions 56 and elbow regions 57 having pleats for extended range of motion, and showing structural feature in insets expansion ribs 58a, expansion slit 58b, ventilation net 58c and ventilation holes 58d;

FIG. 6 presents a schematic illustration of an exemplary 3-parts injection mold 60, showing back mold plate 61, front mold plate 62 and mold core 63, wherein ejector pins 64 fit to ejector sockets 65 to lock mold plates 61 and 62 around mold core 63, and sprues 66 are used to inject the liquid material precursor into the mold's cavity; and

FIG. 7 presents a schematic illustration of an exemplary injection device 70, showing mold plate 71 is held locked tightly to front mold plate 72 closing around mold core 73, thereby forming mold cavity 74 in the shape of a T-shirt, according to some embodiments of the present invention, wherein hydraulic screw drive and gearing assembly 75 is used to inject the liquid material precursor, fed from hopper 76, into barrel 77 and through sprue 78 into mold cavity 74, while heating coil 79 heats the material precursor in initiate polymerization.

### DESCRIPTION OF SPECIFIC EMBODIMENTS OF THE INVENTION

The present invention, in some embodiments thereof, relates to an article-of-clothing and fashion, and more particularly, but not exclusively, to garments based on a seamless wearable structure.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention is directed at a class of garments which is characterized by comprising a seamless wearable structure, rather than being formed from joining several flat panels into a single structure. The present invention is also directed at a class of garments which is characterized by being formed in a process wherein the entire garment, or at least the major part of the garment, is produced at once, as opposed to the hierarchical production of garments that typically includes twisting, spinning, weaving, looming, cutting, sewing, stitching and accessorizing. The present invention is also directed at a class of garments being one-piece, seamless articles-of-clothing, which can be fitted with various appendices and accessories that can be mounted on or attached to structural features in the garment. The present invention is also directed at a class of garments being one-piece, seamless articles-of-clothing having at least one, at least two, at least three or at least four body-part opening.

### Seamless Wearable Structure

According an aspect of some embodiments of the present invention, there is provided a garment which includes a seamless wearable structure.

The term “garment”, as used herein, is meant to encompass article of clothing for humans as well as for animals and pets. In the context of embodiments of the present invention, a garment comprises as a major part thereof a seamless wearable article-of-manufacturing, referred to herein as a structure, which is capable of being worn or is suitable to wear. The term “wearable”, as used herein, means that a person can use the garment as clothing, being at least sufficiently flexible, or sufficiently breathable, or sufficiently stretchable, or sufficiently light weight, or sufficiently protective, or sufficiently concealing, or sufficiently fashionable, comfortable and/or desirable, or any combination thereof.

As known in the art, garments are typically formed by attaching a number of panels, which are flat pieces of fabric cut into predesigned polygons, typically by sewing the sides of the panels, and/or forming tubular structures by rolling a panel and stitching together two opposite sides thereof.

The present invention is therefore drawn to garments that are not made of panels, but rather substantially made of a seamless wearable structure. The term “structure”, as used in the context of the present invention, refers to a monolithic, unified, continuous and cohesive object, which may include at least one sheet-like, tubular and cap-like structural elements, which is used to form a garment. In some embodiments, the structure is a single seamless wearable object. In the context of embodiments of the present invention, a structure includes or one or more tubular structure element.

The term “garment”, as used herein, refers to an article of clothing that is used as an outer covering or outward appearance on a body of a subject. Exemplary garments for humans include, without limitation, undergarment, shirt, pants, dress, baby grow, blazer, blouse, body shaper, boot, boxers, bra, briefs, burka, camisole, cargos, catsuit, chemise, coat, corset, dungarees, glove, gown, hat, headdress, headpiece, hijab, hood, hooded pullover, jacket, jellabiya, jersey, jumper, kimono, knickers, overalls, poncho, pullover, robe, romper, shapewear, shellsuit, shoe, shorts, skirt, skivvy, sock, stockings, strapless, suit, sweatshirt, swimwear, tankini, thong, tights, top, trousers, trunks, T-shirt, underpants, undershirt, vest, waistcoat and wetsuit.

In some embodiments of the present invention, the term “garment” excludes articles-of-clothing intended for use of bodily appendices, such as head, hands and feet, thus the garment is not a headwear (hats, caps and the like), a handwear (gloves, mittens and the like) or a footwear (sock, boot, shoe and the like).

In the context of embodiments of the present invention, a structure may comprise more than one stratum, layer or lamina, wherein the strata share essentially the same planar shape, but not necessarily the same area; hence, a multi-stratum structure, according to some embodiments of the present invention, may have different strata at different regions thereof.

In the context of embodiments of the present invention, a seamless wearable structure may comprise several cohesive regions, cohesive portions or cohesive areas being characterized by seamless transitions from one portion to another, wherein each portion or region may be characterized by a material, a pattern, a thickness, a stratum, a layer, a color, a texture and any combination thereof.

Having at least some sheet-shaped regions/portions, a seamless wearable structure can also be characterized by two sides, which in the context of a garment can be, for example, an inwards side facing and/or touching the body and typically concealed from view, and an outwards facing side, typically visible to a viewer. In some embodiments, the garment is designed such that in some parts the same side flowingly changes from being an outwards facing side to an inwards facing side and vice versa. Such transition is oftentimes achieved by twisting or inverting parts of the structure in the garment.

The terms “one-piece” and “seamless”, are used herein to define the garment as not being formed from several structures attached to one-another, and being devoid of seams and stiches that connect several structures. In some embodiments, the term “seamless” refers to a structure being devoid of seams and stiches that connect two sides or regions of the structure. Thus, the term “one-piece” refers to a unified cohesive structure, and the term “seamless” refers to a structure devoid of seams. The term “seam”, as used herein, refers to any mean of connecting, joining or attaching two objects or two sides of an object together. A seam can be formed, for example, by sewing, gluing, welding, fusing, riveting, stitching or otherwise adjoining two sides of an object or sides of several objects.

In the context of embodiments of the present invention, a garment may be characterized by having one or more body-part openings. The phrase “body-part opening”, as used herein, refers to an opening in a seamless wearable structure for allowing a body part to extend through. For example, a neck opening is an opening for allowing the head and neck to extend through a garment.

Garments can be divided into groups according to the number of body-part openings: half finger or fingerless gloves have six body-part opening, five for the fingers and one for the wrist; baby grows typically have five body-part openings, one for the neck, two for the arms/hands and two for the legs/feet; shirts, tops, bras, jumpers, dresses, pullovers, jackets, jerseys and the likes typically have four body-part openings, for the torso, two for the arms/hands and one for the neck; pants, shorts, tankini, thong, tights, trousers, underpants and the likes typically have three body-part openings, one for the torso and two for the legs/feet; strapless shirts, corsets skirts and the likes typically have two body-part openings; and hats, shoes, gloves, socks, stockings and the likes typically have one body-part opening.

According to some embodiments of the present invention, the garment has one body-part opening. According to some embodiments of the present invention, the garment has two body-part openings.

According to some embodiments of the present invention, the garment has three or more body-part openings. According to some embodiments of the present invention, the garment has at least four body-part openings.

In some embodiments of the invention, the garment has at least one tubular portion/part, which is designed to enclose a tubular body part, such as a torso, a neck, an arm, a leg, a finger and the likes. A tubular portion of a seamless wearable structure has at least two body-part openings wherein at least one of which may be continued to form another part of the structure. For example, a sleeve is a two body-part tubular portion of a garment which is open on one side and typically continues to form a tubular portion/part inclosing a torso.

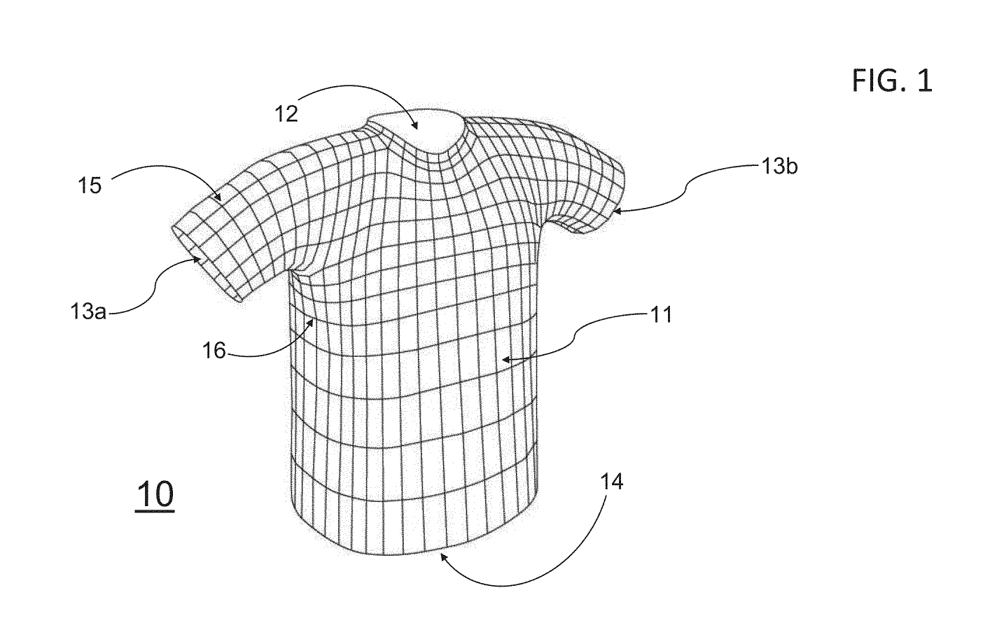

Referring now to the drawings, FIG. 1 presents a schematic wireframe illustration of an exemplary garment, according to some embodiments of the present invention, showing garment 10 comprising seamless wearable structure 11, having four body-part openings, neck opening 12, arm opening 13a, arm opening 13b, and torso opening 14, wherein tubular arm portion 15 is open on one side and continues flowingly into tubular torso portion 16.

### Structural Features and Regions

According to some embodiments, the garment is having at least one structural feature which forms a part of the seamless wearable structure. In the context of a single seamless wearable structure, the term “structural feature”, as used herein, refers to a part of the structure that is structurally or geometrically or conspicuously different that other parts of the structure in one or more characteristics, such as thickness or continuity (hole; void; cut). It is noted that the structural feature is not appended to the structure but is an integral part of the structure. Exemplary structural features include an appendix mounting, a panel, a pattern, a hole, an eyelet, a slit, a mesh, a net, a thickening, a bulge, a protrusion, a prong, one or more pleats, one or more ribs, a fold, a crease, a ridge, a latch, a loop and a strap. Structural features are also afforded by combining more than one type of feature, and afford stamping, engraving, prominence, lacelike (lacy, tatting) patterns.

In some embodiments, the garment exhibits one or more structural features which are placed on the outwards facing side, the inwards facing side, both (e.g., a bulge) or through the structure (e.g., a hole). Structural features can be arranged in particular locations in the garment in singletons, small groups or large groups, orderly arranged in a pattern or randomly distributed.

A structural feature which is a break in the continuity of the structure can be in the form of a hole or a slit. An eyelet or a hole can be used to hitch an appendix to the garment, or be used as a buttonhole. A bulge or a protrusion in the structure can also be used to hitch an appendix to the garment. A pattern of slits and holes can form a mesh or a net region in the structure. Structural regions being a net or mesh may be useful in areas which require more ventilation or heat exchange, or for decorative/fashion consideration (e.g., lacework-like).

A plurality of bulges, protrusions, ribs, folds, creases or ridges can form a structural feature characterized by a regional texture with or without a conceivable repeated pattern or a decorative design motif. A regional structural feature that involves a change in the thickness of the structure may be used to harden, soften or render certain areas of the garment more or less flexible, and/or to give a different texture (feel) and/or a different visible appearance (look).

A structural feature in the form of thickness variations made in a pattern of folds, creases or ridges, may form a set of pleats. Pleats are useful in forming stretchable/elastic or contractible/shrinkable regions in the garment. Following are some exemplary pleat types, as these are known in the art, useful in the context of the present invention. “Accordion pleats” or “knife pleats” are a form of tight pleating which allows the garment to expand its shape when moving, and is useful for garment sleeves, such as pleating the end of the elbow, with the fullness of the pleat gathered closely at the cuff. “Box pleats”, “stacked-” and “double box pleats” are back-to-back knife pleats, create fullness or aired thickness having longitudinal channels which can be useful in many garments to channel heat, moisture and air. “Cartridge pleats” are useful in gathering a tubular portion of the garment into a smaller width. “Fluted pleats” or “flutings” are typically small, rounded or pressed pleats used as trimmings around body opening. Other types of pleats include “fortuny pleats”, “honeycomb pleats”, “kick pleats”, “organ pleats”, “plissé pleats”, “rolled pleats”, “Watteau pleats” and “Kinguissie pleats”.

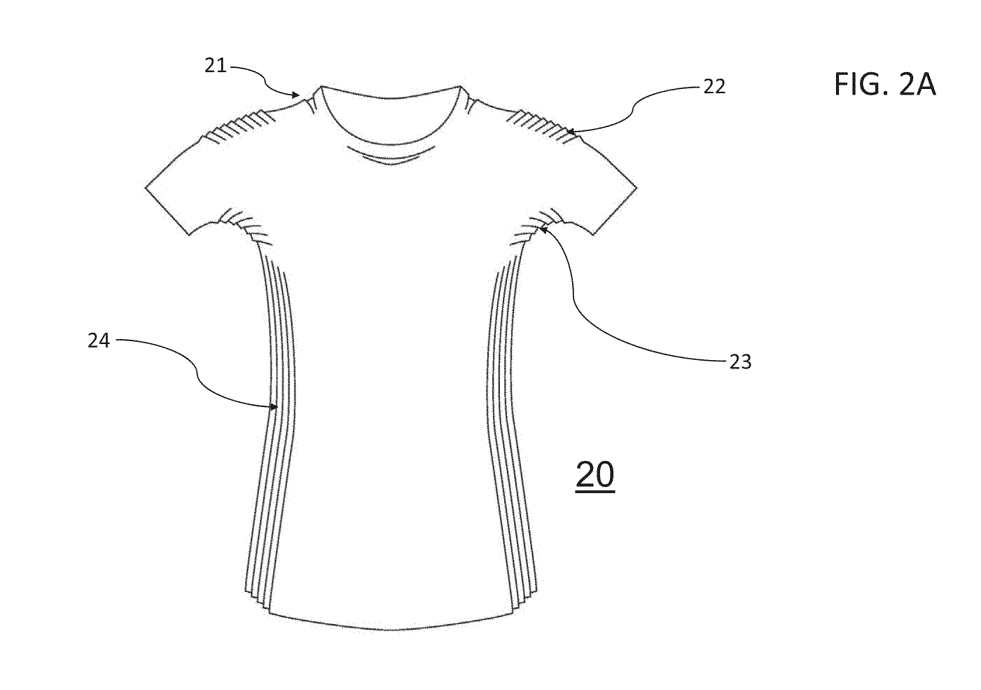

FIGS. 2A-B present schematic illustrations of an exemplary garment, according to some embodiments of the present invention, showing in FIG. 2A garment 20 comprising pleated neck opening structural region 21, pleated shoulder structural region 22, pleated underarm structural region 23, and pleated torso flank panel region 24, wherein each of the pleated structural regions confers stretchability/contractibility to that particular region of the garment, and showing in FIG. 2B garment 20 comprising sleeve folding strap 25, configured to latch on to prong 26 positioned on the shoulder, wherein sleeve 27 is shown folded and held in place by sleeve folding strap 25.

Single structural features and regional structural features (structural regions) may combine geometric features and material variations, as these are discussed hereinbelow. As mentioned hereinabove, the structure can be made from more than one structural regions. Each structural region can be individually characterized by a thickness, a texture, a color, a pattern, and a material.

For example, in some embodiments, the structure comprises a plurality of structural regions, each of which is individually characterized by a thickness that ranges from 0.1 to 10 mm.

For another example, in some embodiments, the structure comprises a plurality of structural regions, each of which is individually characterized by a mass per unit area that ranges from 50 to 400 grams per square meter.

In the context of placing various structural features in the shape and texture of the structure, according to some embodiments of the present invention, a transition from one structural region can be perceived by sight and touch, in some embodiments, the transition can be perceived either sight or touch, and in some embodiments the transition may be sensed by neither sight nor touch.

In some embodiments, the structure is a single layered structure or a multi-layered structure, wherein each layer of the structure can have similar or different structural features (pattern/texture) and/or can be made from a similar or different material, as these are discussed hereinbelow.

### Appendix Mounting and Appendices

One of the optional structural features is designed to allow hitching an appendix to the garment, thus, the term “appendix mounting”, as used herein, refers to a structural feature that is designed to allow appending one or more appendices to or on the garment. Typically, appendix mounting is in the form of a hole, an eyelet, a slit, a thickening and/or a bulge, and a combination thereof.

It is noted that appendices are not regarded as an integral part of the seamless wearable structure. Exemplary appendices include, without limitation, a pocket panel, a button, a zipper, a collar, a cufflink, a belt, a buckle, a hood, a glove, a sleeve, a lace, a thong, a hook, a loop, a fastener, an interlocking hooks strip and an interlocking loops strip (Velcro), and another garment.

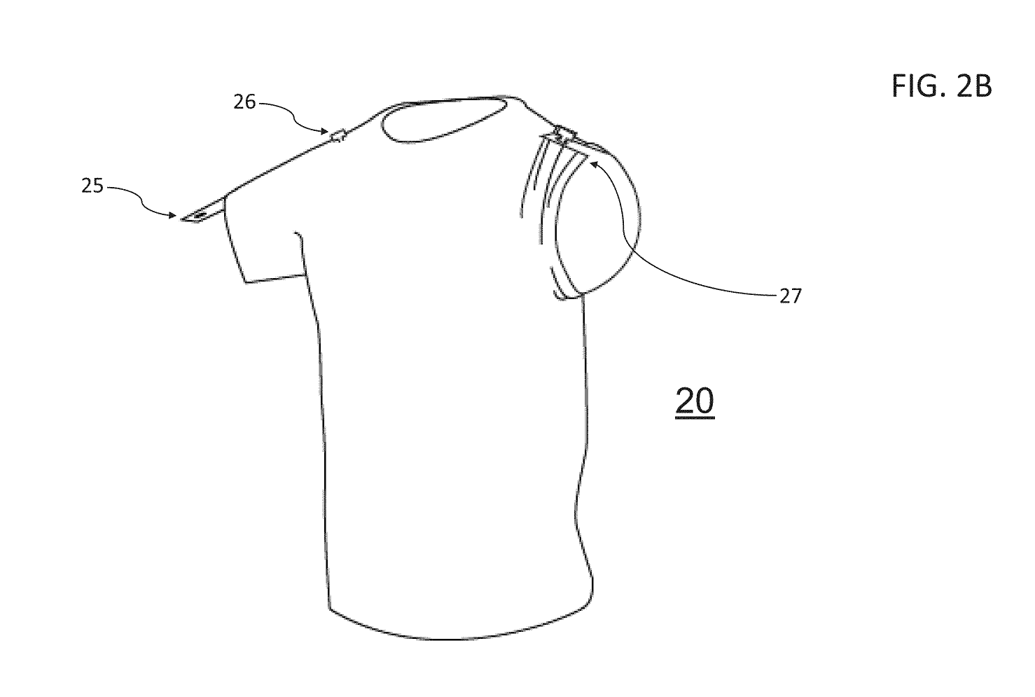

FIGS. 3A-B present an exemplary garment, according to some embodiments of the present invention, showing garment 30 having a set of holes 31 arranged so as to allow hitching pocket panel 32 (FIG. 3A), and showing garment 30 having a pocket made from pocket panel 32 (FIG. 3B).

### Material, Structure and Garment Properties

In some embodiments, the structure is made from one type of material.

Alternatively, as mentioned hereinabove, the structure can comprise more than one regions distinguished from one another by the material comprising the same. In order to distinguish structurally different regions from chemically (material) different regions, the latter are referred to herein as “portions of the garment” or “portions”.

In some embodiments of the present invention the structural comprises a plurality of materials being distributed in a predetermined arrangement of portions of the garment, whereas the portions merge into one-another in a seamless interface.

In the context of use of various materials to form the structural, according to some embodiments of the present invention, a transition from one region to another can be perceived by sight and touch, in some embodiments, the transition can be perceived either by sight or by touch, and in some embodiments the transition may be sensed by neither sight nor touch.

According to some embodiments of the present invention, the seamless wearable structure is not made of a woven fabric, which is typically formed by weaving on a loom, and is made of a plurality of ordered threads. According to some embodiments of the present invention, the seamless wearable structure is not made of a knitted fabric, which is typically formed by knitting a plurality of threads into a consecutive rows of interlocking loops.

According to some embodiments of the present invention, the seamless wearable structure is made of a nonwoven fabric. In the context of embodiments of the present invention, the term “nonwoven” refers to any “cloth-like” sheet-shaped object which is not formed by weaving, knitting, crocheting or knotting of fibers and yarns, and encompasses monolithic sheet-shaped objects as well as fibrous sheet-shaped objects.

The material comprising the structural or portions thereof, determines some of its properties, along with the structural features (pattern, texture, thickness, holes, slits etc.). For a given fixed thickness and area, each material will form a structural that is characterized by at least one, at least two, at least three, at least four, at least five or more of the following material-based properties, as these are known in the art, and for each of which there exists a widely-accepted standard for quantified analysis:

a breathability level that ranges from 0 Ret to 20 Ret according to standard ISO 11092 (the Ret or Hohenstein test);

a drape coefficient that ranges from 10% to 80% according to Cusick drape test;

a stretch and recovery level at 2 kg that ranges from 4% to 400% according to standard ASTM D 3107;

a dimensional stability to laundering after 3 washes (wash-fastness) lower than 5% according to standard AATCC 135;

a tensile strength of at least 10 kg according to standard ASTM D 5034;

a tensile strength testing standard ASTM D638 or ASTM D412;

a tearing strength of at least 1 kg according to standard ASTM D 1424;

an abrasion flex of no rupture or damage for at least 1000 cycles according to standard ASTM D 3885;

an abrasion resistance of no rupture to at least 10,000 cycles according to standard ASTM D 4966;

a water absorbency under 5 seconds according to AATCC/ASTM TS-018; and

a wrinkle recovery/resistance better than 2 on a scale of 1-5 according to AATCC 128/143.

According to some embodiments of the present invention, at least some materials useful in making the garment, are known in the art and are readily available.

Such materials may be synthetic or naturally occurring polymers, co-polymers of synthetic or naturally occurring polymers, fiber-polymer mixtures comprising synthetic or naturally occurring fibers and polymers, polymeric foams, and any mixture thereof.

Naturally occurring polymers include proteins (as in, e.g., wool, mohair and silk), cellulosic (cellulose-base) polymers (as in, e.g., cotton, flax, jute and hemp), and mineral fibers (as in, e.g., asbestos). Natural fibers are made from naturally occurring polymers.

Families of synthetic polymers, processed/artificial polymers and other materials, the members for which are useful in the making of garments according to some embodiments of the present invention include, without limitation, acrylics, acrylonitriles, aramids (nomex; kevlar; twaron), carbon fibers, ceramic fibers, derclon, dyneema/spectra, lyocell, M-5 (PIPD), modacrylic, modal, nylons, polyolefins, orlon, polybenzimidazole (PBI), polyesters, polylactic acid (polylactide; PLA), polyoxazoles, polyvinyl chloride, rayon (artificial silk), saran, spandex, sulfar, tencel, vectran (TLCP; vectra LCP polymer), vinalon, vinyon, zylon (PBO), and any combination thereof, as well as metal and glass.

Preferable synthetic polymers include, without limitation, thermoplastic elastomers based on styrene, ethylene, butylene, isoprene and their block copolymers, polyesters, polyamides, acrylics, polyurethanes, water soluble polymers, polymers soluble in organic solvents, emulsions or suspensions in solvents or their mixtures. Preferably, contemplated polymers include styrene-ethylene-butylene-styrene copolymer (SEBS) and/or styrene-isoprene-styrene (SIS) copolymer.

Any of the above-mentioned polymers can be diluted in a solvent, such as, without limitation, water, ethanol, methanol, other alcohols, acetone, MEK, other ketones, hydrocarbons, halogenated hydrocarbons, DMF, THF, ethyl acetate, diethyl ether, petroleum ether, other ethers, and mixtures thereof.

In some embodiments, the garment is designed for temporary use as a disposable garment. In such embodiments, it is preferable that the material from which the garment is made would be degradable into environmentally friendly materials. Garments made from polymers can be designed to be degradable by formulating the polymer to exhibit at least some degradable bonds therein, and preferably designed to decompose upon extended exposure to ambient conditions, such as moisture, oxygen, light and microorganisms. Exemplary degradable polymers which are useful in the production of textile for garments include, without limitation, poly(desaminotyrosyl-tyrosine dodecyl dodeca-nedioate) (p(DTD DD)) and poly(L-lactic acid) (PLLA).

The material can have a microstructure that endows some of the properties mentioned hereinabove. The term “microstructure”, as opposed to macrostructure properties such as thickness and shape, refers to the arrangement of structural elements in the formed and cured material at the microscopic level (about 0.5-500 microns). For example, a polymeric material can be cured to form a foam, which is highly porous and light in density compared to an object of equal size made from the same polymer in solid bulk form.

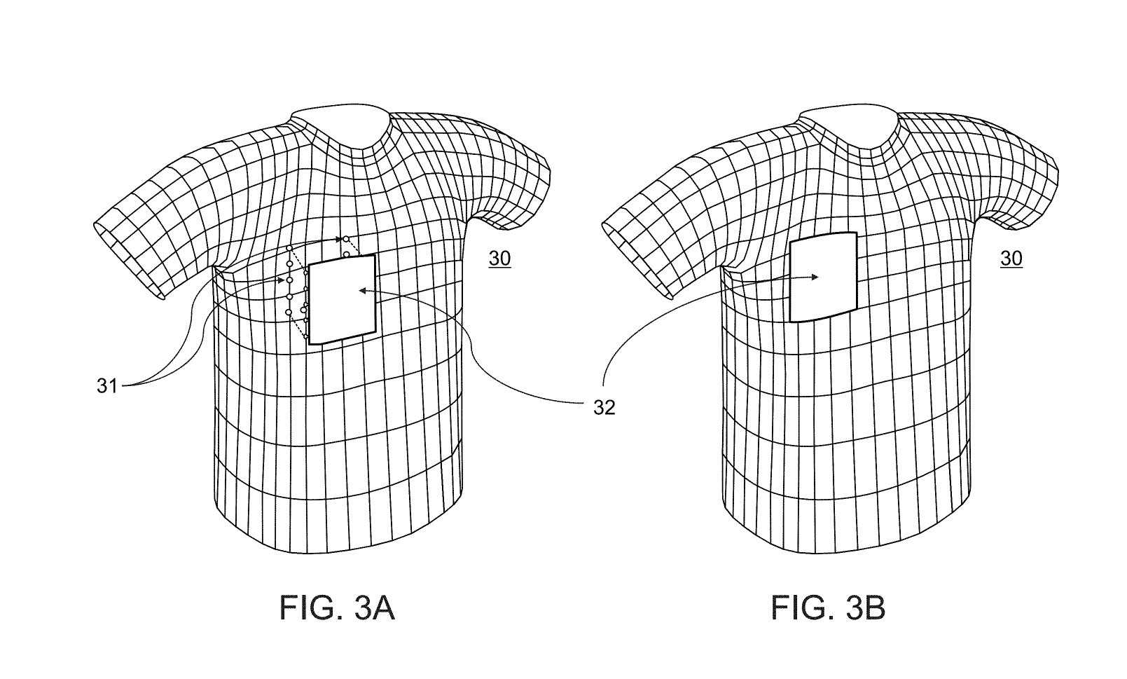

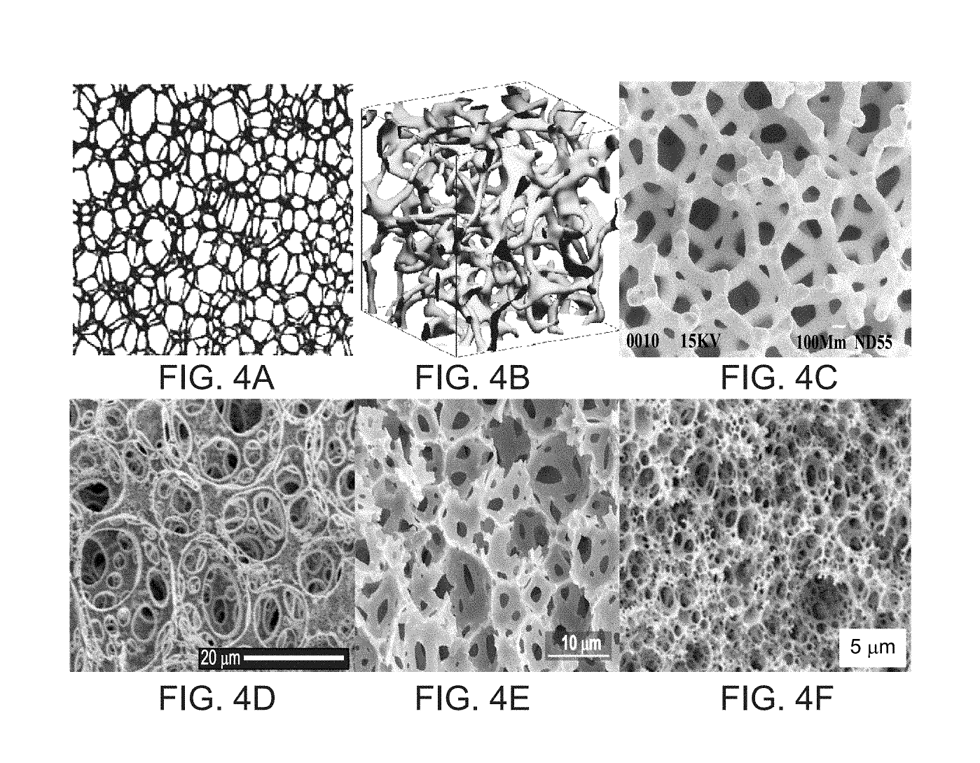

FIGS. 4A-F present exemplary microstructures useful in making at least some portions of the garment, according to some embodiments of the present invention, wherein FIGS. 4A-B show schematic illustrations of the microstructure of some reticulated foams, FIG. 4C shows an electron micrograph of a reticulated foam, and FIGS. 4D-F show a class of foams known as open-cell polymerized high internal phase emulsions (polyHIPEs).

A review of recent developments in polyHIPE technology which is useful in the context of some embodiments of the present invention, can be found in an article by Silverstein, M.S. [“PolyHIPEs: Recent advances in emulsion-templated porous polymers”, Progress in Polymer Science, 2014, 39, p. 199-234] and references cited therein, which are incorporated herein by reference.

A review of recent developments in reticulated and auxetic foams technology which is useful in the context of some embodiments of the present invention, can be found in an article by Critchley, R. et al., [“A review of the manufacture, mechanical properties and potential applications of auxetic foams”, Phys. Status Solidi B, 2013, 250(10), pp. 1963-1982], and references cited therein, which are incorporated herein by reference.

### Methods and Processes of Forming the Garment

In some embodiments of the present invention, the seamless wearable structure forming the garment presented herein, is produced in a unified process step.

In other words, the entire structure is produced in its final three-dimensional shape, including structural features and portions if present, in one unified process. In some embodiments, the process by which the structure is formed, defines the structure resulting therefrom, namely, the chemical, mechanical/physical and structural characteristics of the structure are determined by the process used to form the structure. For example, in some embodiments, the structure is manufactured processes that include, for example, molding processes, spinning processes, dipping processes, painting/brushing processes and spraying processes.

It is noted that 3D printing, referring to a range of versatile additive manufacturing processes, as this term is used in the art, is limited in its capacity to produce garments effectively, as contemplated in the present invention, due to the following inherent practical reasons. 3D printing is a process that is used to produce one object at a time, following a digital representation of the object using materials that are selected based on their adequacy to the 3D printing process. This process is inherently slow and expensive, typically resulting in object of limited usability as a garment due to poor or insufficient mechanical properties, such as ductility and flexibility, strength and stretchability, breathability and drape. Thus, due to the cost and the general frailty and incompatibility of the materials used in 3D printing in the context of garments, this type of process is excluded from the scope of the present invention. Thus, the seamless wearable structure presented herein is not manufactured by a 3D printing process.

Since painting, bushing and spraying may be seen as forms of additive manufacturing processes, albeit typically not following a digital representation of the object and typically not executed by a computerized and fully automated process, in some embodiments, the seamless wearable structure presented herein is not manufactured by a painting, a bushing or a spraying process.

According to an aspect of some embodiments of the present invention, there is provided a method of manufacturing the garment presented herein, which includes manufacturing a seamless wearable structure, as provided herein, by a process selected from the group consisting of mold injection, mold casting, spinning, dipping, painting/brushing and spraying.

In some embodiments, the garment consists of the seamless wearable structure provided herein, namely the garment is complete once the structure is produced. In the context of such embodiments, the process of producing the structure includes removing from the finished structure excess material left in the sprue (it is noted that this excess material is sometimes also called a sprue), removing materials from holes and openings in the structure that are left in their place after molding, and generally cleaning the structure from excess material.

In some embodiments, the method further includes attaching an appendix to the seamless wearable structure, after it has been produced by any one of the aforementioned processes. In some embodiments, an appendix can be attached or integrally formed in or on the seamless wearable structure during the production of the structure in any one of the aforementioned processes.

In some embodiments, the method includes adding sacrificeable materials to the mold or model in or on which the structure is formed, or adding sacrificeable materials to the material precursor from which the structure is formed. A sacrificeable material is a material that is essentially removed from the structure and leaves an imprint or a hole in the structure after its removal. For example, particles a sacrificeable water-soluble substance, which are added to the material precursor that is injected into a mold to form a structure, will be dissolved when the structure is placed in water, leaving voids in their place, thereby rendering the material of the structure porous, or mesh-like. In another embodiment, an object made of a sacrificeable low melting substance, placed within the cavity of a mold before casting or injecting the material precursor, will melt during the molding process or thereafter, leaving a void in its place, thereby forming a structural feature in the finished structure.

Molding

In molding processes, a mold having a cavity in the shape of the seamless wearable structure is filled with a cast, a liquid or powder precursor of the material(s) comprising the structure, referred to herein as a material precursor, and once cured, the mold or opened to release the structure. Molding processes include casting and injection processes (mold casting; mold injection). The mold can be as simple as having two parts that form a cavity therebetween when put together and can be separated to release the cured structure from therein. In other embodiments, the mold is a multi-part mold, which when assembled, is having a cavity therein in the shape of the structure. Any two- or multi-part mold can be taken apart to release the cured structure formed therein. In the case of a structurally complex structure, the mold and cavity may be designed so as to allow the release of the structure. In some embodiments, the releasing step of the structure from the mold is based on the elasticity of the structure at least in some regions and/or parts thereof. In some embodiments the cavity is designed in a shape that allows release of the structure, which once released, takes a different form than the cavity based on stretchable and/or contractible regions/portions in the structure.

According to an aspect of embodiments of the present invention, there is provided a mold for manufacturing the structure presented herein, comprising at least one mold cavity in the shape of the structure and at least one sprue.

In some embodiments, the mold has at least one sprue for inletting the cast (material precursor) into the cavity. The sprue can be used for pouring or injecting the cast into the cavity. In some embodiments of the invention, injection may be a preferred mode of casting for reasons known to the skilled artisan of the art. A single sprue may be sufficient for manufacturing some structures; alternatively, the mold comprises a plurality of sprues for a more efficient and effective introduction of the material precursor into the entire cavity. In some embodiments, sprues are distributed in the mold for feeding material precursor into the cavity in a predetermined arrangement of locations in the cavity, such that the seamless wearable structure is formed with a predetermined arrangement of portions. In some embodiments, different materials can be injected into certain sprues according to a predetermined arrangement of sprues and portions. In such embodiments, each of a plurality of sprues is configured individually for delivering a different and/or an identical liquid or powdered precursor of the material (cast) to form a predetermined arrangement of portions in the structure.

In order to form structural features and regions in the structure the mold is having one or more molding features attached thereto on the surface of the cavity.

The molding features correspond in shape to the desired structural features, as these are discussed hereinabove. In some embodiments, the molding features are made from sacrificeable substances.

Dipping and Spraying

Dipping and spraying processes useful in the context of some embodiments of the present invention, are based on a physical model of the structure, the surface of which is used to apply directly thereon, by dipping or spraying, a liquid or powdered precursor of the material(s), which cures to form the structure. Once the material is cured, the formed structure is removed from the model.

Dipping and spraying processes the particularly useful for forming a multi-stratum structure. For instance, the model or parts thereof can be dipped or sprayed with a first material precursor, and thereafter the model or (identical or different) parts thereof can be dipped or sprayed with a second material precursor, thereby forming a bi-layered structure at least in some portions thereof. In some embodiments, a sequential dipping or spraying takes place several times, each time with the same or a different material precursor, thereby forming a multi-strata structure.

The surface of the model can be configured to exhibit holes, bulges, grooves and ridges, collectively referred to as model surface features, corresponding to various structural features, as these are discussed hereinabove. The material precursor(s) that cures on the model having such model surface features will give rise to a structure having the corresponding structural features.

Spinning

According to some embodiments of the present invention, the garment can be produced by various spinning techniques, wherein a surface of a model is used to spin thereon fibers made of various materials or precursors thereof that fuse together directly onto the model to form a seamless wearable structure, thereby taking the shape of the model. The model for spinning fibers thereon is essentially similar to the model used for dipping and spraying, as presented hereinabove, at least in terms of overall shape and model surface features.

Spinning processes the particularly useful for forming a multi-stratum structure, wherein each stratum is formed by spinning an identical or different type of precursor, allowing the based layer to cure at least partially before spinning the next stratum thereon.

Various fiber spinning techniques include, without limitation, solution spinning, electro-spinning, wet spinning, dry spinning, melt spinning and gel spinning. Each spinning method imparts specific physical dimensions and mechanical properties of the spun fibers and the resulting seamless wearable structure, and can be tuned to give the desired characteristics according to the required properties of the material(s).

In some embodiments of the spinning process, fibers are spun on the model in a certain direction and/or orientation, either randomly or according to a pattern or a region in the structure. Nonetheless, the fibers are not weaved or knotted with one-another, thereby forming a nonwoven seamless wearable structure. The fibers are allowed to stick to one-another by fusing at least partially, thereby forming a continuous structure.

Various fiber spinning techniques typically involves the use of spinnerets. In some embodiments, a spinneret may have one to several hundred small holes. As the filaments, or crude fibers, emerge from the holes in the spinneret, the dissolved or liquefied polymer is converted first to soft fusible fibers which is then cured and solidified. In the context of embodiments of the present invention, this process of extrusion and solidification of “endless” crude fibers is referred to as “spinning”, which is not to be confused with the operation of the same name in the woven textile field, where short pieces of staple fiber are twisted into yarn.

In some embodiments, the fiber is made of one or more polymers. Such polymeric fibers can be produced, for example, by the fiber spinning processes detailed hereinbelow. Non-polymeric fibers can be produced, for example, by melt-spinning.

Wet spinning is used for fiber-forming substances that have been dissolved in a solvent. The spinnerets are submerged in a chemical bath containing the model in a precipitating liquid, and as the filaments emerge they precipitate from solution and solidify directly onto the model. Alternatively, the spinnerets release fibers onto a model and a precipitating liquid is applied concomitantly thereon. Because the solution is extruded and contacted with the precipitating liquid, this process for making fibers is called wet spinning. Materials made of acrylic, rayon, aramid, modacrylic and spandex can be produced by this process.

Dry spinning is also used for fiber-forming substances in solution, however, instead of precipitating the polymer by dilution or chemical reaction, solidification is achieved by evaporating the solvent in a stream of air or inert gas. The filaments do not come in contact with a precipitating liquid, eliminating the need for drying and easing solvent recovery. This process may be used for the production of materials such as acetate, triacetate, acrylic, modacrylic, PBI, spandex and vinyon.

In melt spinning, the fiber-forming substance is melted for extrusion through the spinneret and then the crude fibers are spun directly onto the model, fuse and cured typically by cooling. Melt spun crude fibers can be extruded from the spinneret in different cross-sectional shapes (round, trilobal, pentagonal, octagonal and others).

Materials such as nylon (polyamide), olefin, polyester, saran and sulfar are produced in this manner.

Gel spinning is a special process used to obtain high strength or other special fiber properties. The polymer is not in a true liquid state during extrusion. Not completely separated, as they would be in a true solution, the polymer chains are bound together at various points in liquid crystal form. This produces strong inter-chain forces in the resulting filaments that can significantly increase the tensile strength of the fibers.

In addition, the liquid crystals are aligned along the fiber axis by the shear forces during extrusion. The filaments emerge with an unusually high degree of orientation relative to each other which increases their strength. The process can also be described as dry-wet spinning, since the filaments first pass through air and then are cooled further in a liquid bath. Some high-strength polyethylene and aramid fibers are produced by gel spinning.

Electro-spinning is a process used to form very thin fibers. In this process the fibers are drawn out from a viscous polymer solution or melt (material precursor) by applying an electric field to a droplet of the solution, typically at the tip of a metallic needle. The electric field draws this droplet into a conical structure. If the viscosity and surface tension of the solution are appropriately tuned, varicose breakup is avoided without reaching electro-spray and a stable continuous jet of the liquid polymer is formed. The tendency to bend results in a whipping process which stretches and elongates the emerging fiber until its diameter is reduced to few micrometers or even nanometers, and the fiber is then deposited on a grounded collector spool.

While extruded crude fibers are solidifying, or in some cases even after they have hardened, the crude fibers may be drawn to impart strength and other flexibility thereto.

As they emerge from the spinneret, the crude fibers have little molecular orientation, and their slight birefringence quality (double refraction), which is used to quantify their degree of internal molecular orientation and a measure of molecular anisotropy versus crystallinity, is due to shear forces set up during extrusion stage. In order to achieve desirable properties through molecular orientation and crystallinity, the newly formed crude fibers may be drawn. Drawing pulls the molecular chains together and orients them along the fiber axis, creating a considerably stronger fiber.

Depending on the specific fiber-forming substance used, the fibers can be cold drawn or hot drawn. The fibers are drawn to several times their initial length, and the effect of drawing is monitored by its effect on birefringence. Along with the tensile strength of the fiber, the elastic modulus increases significantly with increasing orientation. Other physical properties, such as density equilibrium, moisture sorption, tenacity and elongation-at-break are also affected by drawing. The degree of drawing is typically defined by the term “draw-ratio”, which is a measure of the degree of stretching during the orientation of a fiber or a filament, representing the ratio of the length of the un-drawn fiber to that of the drawn fiber.

When using a spinning process, the required mechanical properties of the structure or portions thereof, and thereby the garment, are substantially determined by the mechanical properties of the spun and fused fibers. Therefore, the thickness, tensile strength and the elasticity modulus of the structure are partially set at the stage of spinning, and finally at the stage of fusing and curing.

### An Exemplary Garment

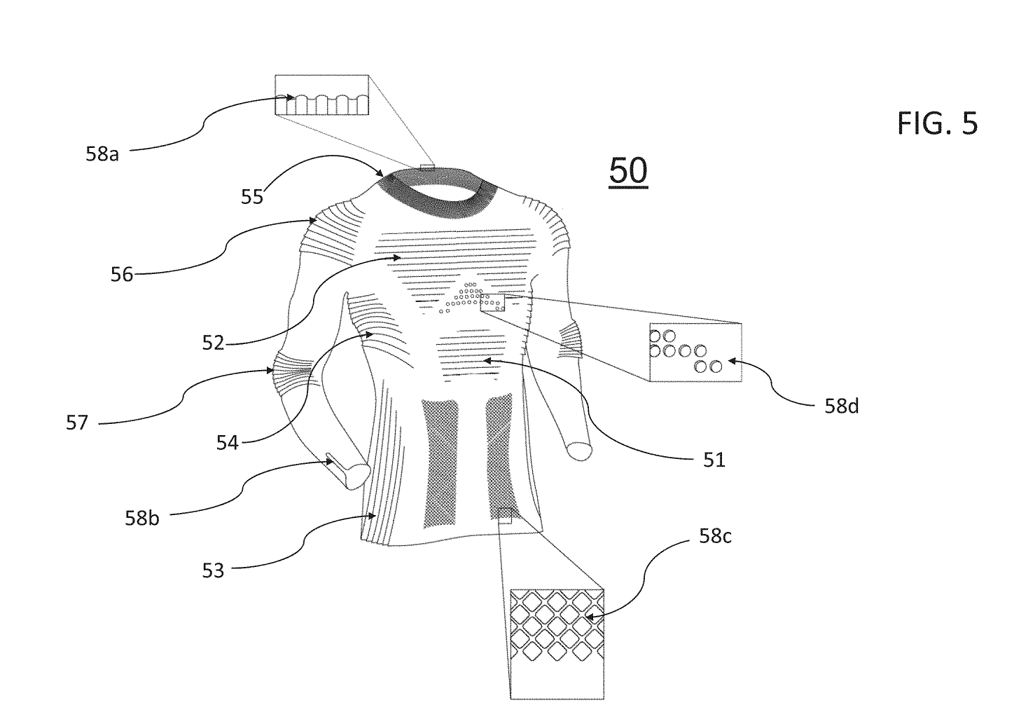

FIG. 5 presents an illustration of an exemplary garment, according to some embodiments of the present invention, showing garment 50 having front-side portion 51 comprising a highly breathable material, chest portion 52 and hip region 53 being thicker for improved impact protection, underarm region 54 comprising a flexible material, neck-opening region 55 being expandable and contractible, shoulder regions 56 and elbow regions 57 having pleats for extended range of motion, and showing structural feature in insets expansion ribs 58a, expansion slit 58b, ventilation net 58c and ventilation holes 58d.

This garment is optionally characterized by at least one of:

a breathability level that ranges from 0 Ret to 20 Ret according to standard ISO 11092 (the Ret or Hohenstein test), or another industry acceptable standard for breathability;

a drape coefficient that ranges from 10% to 80% according to Cusick drape test, or another industry acceptable standard for drape;

a stretch and recovery level at 2 kg that ranges from 4% to 400% according to standard ASTM D 3107, or another industry acceptable standard for stretch and recovery;

a dimensional stability to laundering after 3 washes lower than 5% according to standard AATCC 135, or another industry acceptable standard for dimensional stability and wash fastness;

a tensile strength of at least 10 kg according to standard ASTM D 5034, or another industry acceptable standard for tensile strength, such as ASTM D638 or ASTM D412;

a tearing strength of at least 1 kg according to standard ASTM D 1424, or another industry acceptable standard for tearing strength;

an abrasion flex of no rupture or damage for at least 1000 cycles according to standard ASTM D 3885, or another industry acceptable standard for abrasion flex;

an abrasion resistance of no rupture to at least 10,000 cycles according to standard ASTM D 4966, or another industry acceptable standard for abrasion resistance;

a water absorbency under 5 seconds according to AATCC/ASTM TS-018, or another industry acceptable standard for water absorbency; and/or

a wrinkle recovery/resistance better than 2 on a scale of 1-5 according to AATCC 128/143, or another industry acceptable standard for wrinkle recovery/resistance.

It is expected that during the life of a patent maturing from this application many relevant garment comprising a seamless wearable structure will be developed and the scope of the term “seamless wearable structure” is intended to include all such new technologies a priori.

As used herein the term “about” refers to ±10%. The terms “comprises”, “comprising”, “includes”, “including”, “having” and their conjugates mean “including but not limited to”.

The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a certain property or characteristic, refer to a process, a composition, a structure or an article that is totally devoid of the property or characteristic or characterized by less than about 5, 1, 0.5 or 0.1 percent of the property or characteristic, compared to a given standard.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a material” or “at least one material” may include a plurality of materials, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non-limiting fashion.

### Example 1

### A T-shirt by Injection Molding

A garment in the shape of a T-shirt is prepared according to some embodiments of the present invention, from a polymeric material that cures to form a stretchable and breathable material having a microstructure of an open-cell foam. The T-shirt is produced by mold injection of liquid HIPE that cures upon heating.

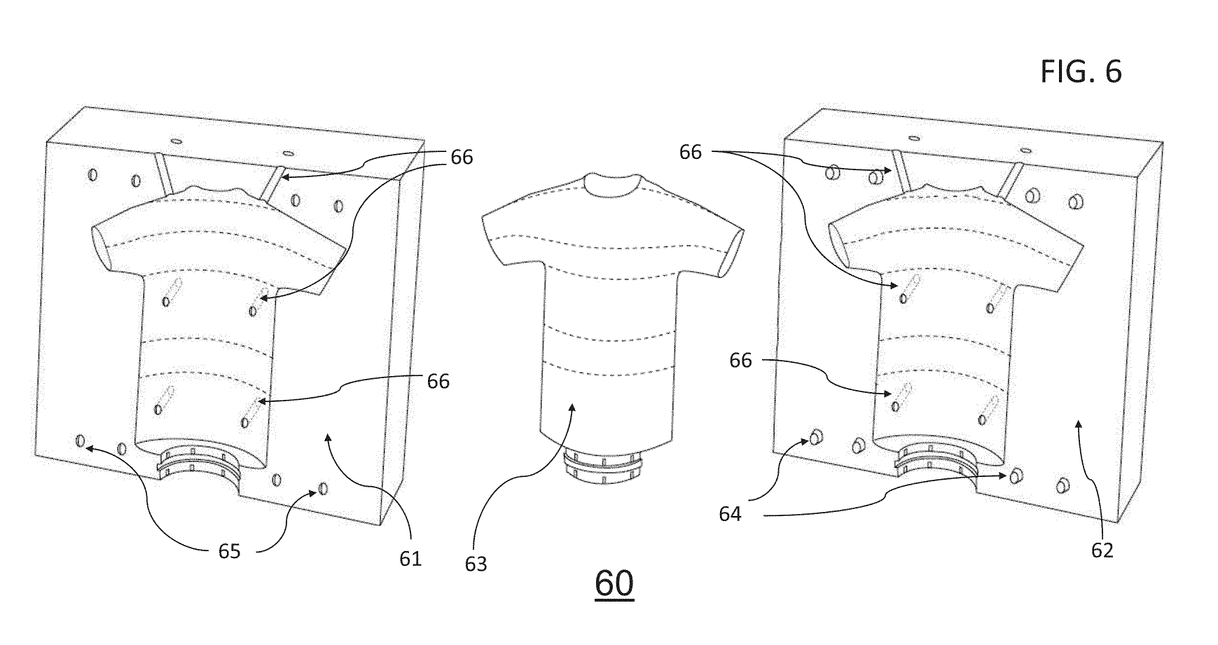

FIG. 6 presents a schematic illustration of an exemplary 3-parts injection mold 60, showing back mold plate 61, front mold plate 62 and mold core 63, wherein ejector pins 64 fit to ejector sockets 65 to lock mold plates 61 and 62 around mold core 63, and sprues 66 are used to inject the liquid material precursor into the mold's cavity.

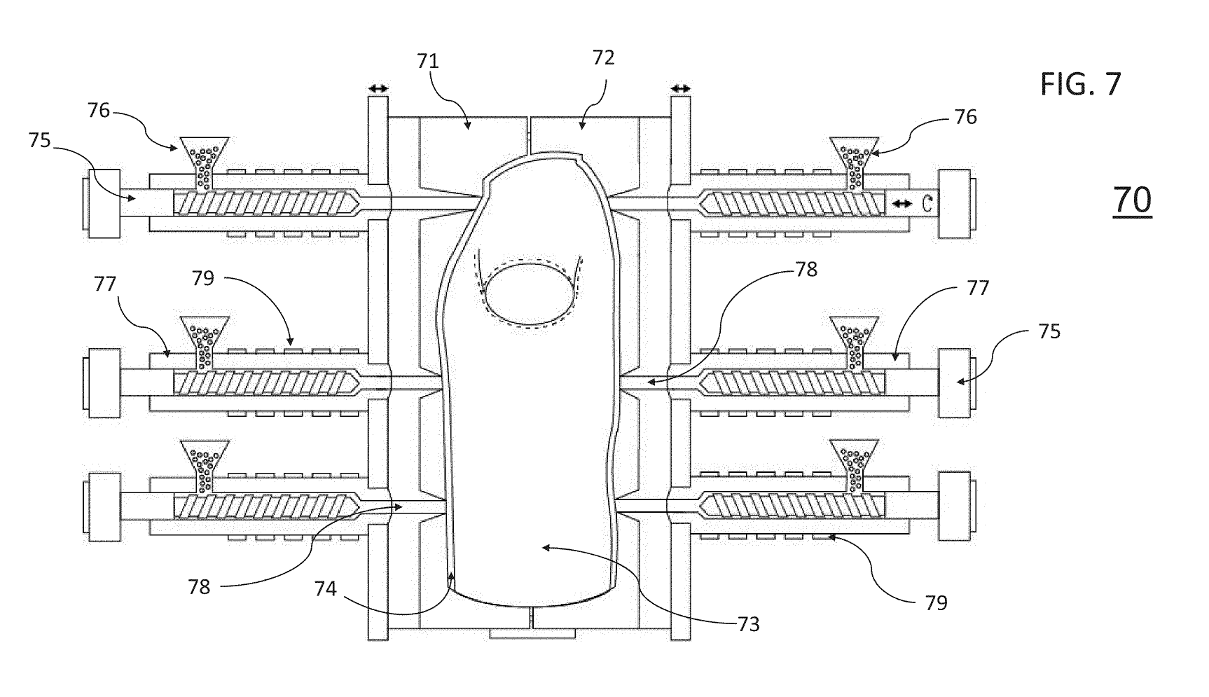

Injection mold 60 is used to prepare a T-shirt as shown in FIG. 1, wherein the T-shirt is made in a unified injection process from a light-weight elastic open-cell polyHIPE as shown in FIGS. 4D-F, using an exemplary injection device as shown in FIG. 7.

FIG. 7 presents a schematic illustration of an exemplary injection device 70, showing mold plate 71 is held locked tightly to front mold plate 72 closing around mold core 73, thereby forming mold cavity 74 in the shape of a T-shirt, according to some embodiments of the present invention, wherein hydraulic screw drive and gearing assembly 75 is used to inject the liquid material precursor, fed from hopper 76, into barrel 77 and through sprue 78 into mold cavity 74, while heating coil 79 heats the material precursor in initiate polymerization.

Once the injection step is completed, as can be attested by viewing excess material precursor being pushed out of the mold cavity, the mold is opened and the mold core is released. Once the material is set (cured), the garment is stripped off the mold core to afford the T-shirt.

### Example 2

### A Raincoat by Spraying

A garment in the shape of a raincoat was prepared according to some embodiments, by spraying a polymeric composition onto a model of the human body (manikin).

Contemplated garments for the below demonstration of some embodiments of the present invention include all top garments, including raincoats and T-shirts. Since each garment has different properties and requirements, the first phase of the development was defined based on the specifications of a raincoat:

Impermeable to water, “strong ”, flexible but not elastic, inner smooth surface, and relatively thick. The outer surface of the raincoat was chosen to be reflective, and contain a yellow reflective dye.

Polymer solutions were prepared by stirring or shaking and/or heating a polymer or a blend of polymers and solvents or solvents mixtures. The contemplated polymers include thermoplastic elastomers based on styrene, ethylene, butylene, isoprene and their block copolymers, polyesters, polyamides, acrylics, polyurethanes, water soluble polymers, polymers soluble in organic solvents, emulsions or suspensions in solvents or their mixtures. Preferably, contemplated polymers include styrene-ethylene-butylene-styrene copolymer (SEBS) and/or styrene-isoprene-styrene (SIS) copolymer with typically low styrene content, and specifically 10-35% polystyrene were used for their low hardness and high elasticity. More specifically, functionalized SEBS such as maleic anhydride-SEBS were dissolved in petroleum ether, diethyl ether or a mixture thereof. Use of petroleum ether solutions resulted in a slightly better flexibility.

Other contemplated solvents include water, ethanol, methanol, other alcohols, acetone, MEK, other ketones, hydrocarbons, halogenated hydrocarbons, DMF, THF, ethyl acetate, diethyl ether, petroleum ether, other ethers, and mixtures thereof.

The solutions were sprayed and/or brushed by means of a spray gun, air brush, brush or foam pad, dip coated or injected on different substrates and molds, either flat or shaped, so as to allow for evaporation of the solvents and formation of a film or sheet. The drying process can be heat-assisted or vacuum-assisted. Spraying propellants included aliphatic hydrocarbons, carbon dioxide, and volatile ethers such as DME.

The choice of solvent controls the evaporation rate, film formation and transparency, among other properties. Furthermore, the concentration of polymer in the solution affects viscosity, drying time and resulting thickness. Typical concentrations were 0.1 wt. % to 10 wt. %, or 0.5 wt. % to 5 wt. % dissolved polymer in the solvent.

The application method affects the resulting thickness and transparency. For example, in SEBS solutions in petroleum ether, brushing lead to thin, transparent coatings, whereas spraying resulted in thicker, translucent or opaque coatings.

Work was performed in adequate ventilated areas or in a chemical hood or spray cell, with appropriate safety garments, nitrile gloves and masks where required, following Good Practice Instructions for work with chemical agents and solvents.

Various additives were considered in order to confer and control selected properties. These include foaming or antifoaming agents, thickeners, plasticizers, crosslinking agents, pigments and other additives that are known to modify thermoplastics and thermosets. The choice of polymer afforded control of tackiness, self-adhesion, strength, hardness and porosity, among other properties.

Various surface textures were obtained by applying the solution on a textured substrate, or as a result of evaporation rate of the solvent, thus resulting in controllable surface roughness.

Elasticity of the film or sheet can be controlled by applying several layers, where each layer is made of a different material with different properties, according to some embodiments of the present invention. For example, layers of SEBS and PCL can be applied alternatively to obtain a rather strong, slightly elastic film or sheet. The order of layers can be altered to modify the mechanical behavior and/or the inner and/or outer surface finish. The time elapsed between layers affects the thickness, internal structure and strength. Layer thickness may vary between few microns and several tens of millimeter, and multi-layering can result in a sheet of several millimeters thick.

In a specific embodiment, Kraton FG1901, a maleic anhydride-functionanlized SEBS, was dissolved in petroleum ether, at a concentration of 4 wt. %, and sprayed on a glass model. The resulting film or sheet separated easily from the model, was flexible but not elastic, and the thickness was controlled by the spraying time per area. The surface roughness depended on the concentration of the polymer in the solvent. A smooth surface was obtained on the model sides, whereas a rougher surface was obtained on the board sections thereof. A smooth surface can also be obtained on the board sections by applying a release film, such as a fluorinated polymer film which can be easily removed post-production. Intermediate roughness have also been demonstrated by applying release films with controlled texture.

In another specific embodiment, layers of an elastic film, such as SEBS, and layers of a less elastic film, such as PCL were sprayed alternately in several arrangements, where the arrangements allow for control of thickness, surface roughness and mechanical properties. PCL was dissolved in THF, at a typical concentration of 30 wt. % for a low molecular weight PCL and as low as a few wt. % for a high molecular weight PCL. The molecular weight of PCL gave some degree of freedom when designing a solution for its concentration and the resulting thickness at a certain spray time per unit area.

Sample 1: 20 layers of SEBS and 20 layers of PCL were alternated in an ABAB structure arrangement. The resulting sheet was 0.8 mm thick, rigid and strong, opaque.

Sample 2: several layers of SEBS were coated with layers of PCL on both sides, with a resulting thickness of 0.55 mm. The sheet was rather elastic, moderately strong, and opaque.

Sample 3: same as Sample 2 but PCL coating only on one side. The PCL face was very smooth.

In all samples the number of layers controls the thickness, from tens of mm to 1 mm and more. The ratio of SEBS to PCL layers controlled the flexibility and elasticity. A 1:1 ratio afforded a rigid sheet, and a higher ratio introduced flexibility and elasticity, up to several hundreds of stretch elongation.

In another specific embodiment, a multi-layered product having 30 alternating layers of SEBS and PCL, described as B₂A₅B₂A₅B₂A₅B₂A₅B₂ arrangement, where A is SEBS and B is PCL, was produced. SEBS was applied on the substrate and gave a smooth appearance, whereas PCL gave a rougher appearance on the free surface. These two types of layeres can be interchanged to afford different textures. The opaque sheet separated easily from the glass model, was flexible but not elastic, and had a thickness of about 0.75 mm, with a measured tensile strength of 4 MPa and 20% elongation to break, as determined by ASTM D638 and/or ASTM D412 standards. The reported tensile properties are those of the baseline polymer sheet, and can be easily modified by adding fillers, especially fibrous fillers, as is known to those skilled in the art.

In another specific embodiment, cellulose acetate (ethylcellulose polymers) was dissolved in acetone/ethanol mixtures. In a particular example, Ethocel™ 300 was used in a concentration of about 8 wt. %, whereas other Ethocel™ grades affected the final mechanical properties. Plasticizers and additives such as triethyl citrate and polyethylene glycol (PEG) were introduced to modify the elongation to break, thermal properties and appearance. Typical concentrations of such additives were about 1.5 and 2.5 wt. % triethyl citrate, and 3 wt % PEG. Layers of cellulose acetate were incorporated in multilayered films and sheets with Kraton FG1901 SEBS, resulting in an opaque, flexible, elastic structure. The inner surface contacting the model was smooth, and the outer surface was slightly textured, whereas roughness was controlled by choice of solvents and the use of release films.

In another specific embodiment, multi-layered product having 30 alternate layers of SEBS and cellulose acetate described as B₂A₅B₂A₅B₂A₅B₂A₅B₂ arrangement, where A is SEBS and B is PCL, was produced. SEBS was applied on the substrate and gave a smooth appearance, whereas cellulose acetate gave a slightly textured appearance on the free surface. These two can be interchanged to give different textures. The opaque sheet separates easily from the glass substrate, is flexible and elastic, has a thickness of about 0.5 mm, with a measured tensile strength of 2 MPa and 30-50% elongation to break, as determined by ASTM D638 and/or ASTM D412 standards.

The strength of the resulting fabric was be enhanced by adding fillers such as iron oxide, at a concentration of 0.25 wt. %, imparting a pink or red color.

In another specific embodiment, liquid polymers or oligomers were sprayed, brushed, dip-coated or injected in a similar way. As an example, acrylic based liquid resins were sprayed on various models and heat cured to obtain a solid film or sheet. Compositions included crosslinking agents, compatibilizers, thickeners, nano- or micro-fillers or fibers, functional additives, pigments and the likes. For use of fiber additive, preferably at least 80% should have a length of at least 0.02 mm, and no more than 10 mm.

For example, flock was applied on the surface of the forming film or sheet, to modify its appearance, friction coefficient, color and feeling. Flock was either applied on the wet surface or released from a release paper when applying the polymer solution or liquid polymer on flock. Control over film thickness and viscosity allows for a range of coverings, from open, porous structures to fully coated fibers. Partially coated flock has a “Lycra” hand feel, it is elastic and flexible, porous, and has low friction coefficient.

In another specific embodiment, thickness was increased to affect the drying time and the morphology. Thick applications may lead to porosity, and in some cases large bubbles were captured in the bulk, thus conferring a decorative effect. Bubble size can range from microns to millimeters. Choice of solvent also affects the drying time. More volatile solvents lead to larger pores or bubbles in the bulk.

In another specific embodiment, a SEBS polymer composition, prepared as described above was sprayed over a model using a Sagola nozzle Model 4100G operating at a nominal pressure of 0.7 MPa and an aerial weight of 40 milligrams per square centimeter. The polymeric composition was sprayed evenly to afford a 0.35 mm thick layer over at least 1000 cm² area of the model which included cylindrical elements (e.g., sleeve).

Thereafter partial drying of the layer was allowed, either at room temperature or under heating, before the next layer was applied. The drying period may control the adhesion between layers, the optimum being the lowest time possible without the risk of void formation, usually several seconds depending on the thickness of the individual layer. Consequently, an ethyl cellulose polymer composition prepared as described above was sprayed over the SEBS layer essentially under the condition using the same nozzle.

The application of a SEBS layer was repeated once more over the ethyl cellulose layer, and the application of the ethyl cellulose polymer was also repeated to afford a final ABAB layered fabric.

The fabric was pulled off the model and standard test specimens according to ASTM D638 with cross section 12.7 mm×0.35 mm were cut and tested in a Lloyd LR10k tensile machine at 50 mm/min. The tensile strength was 3.3 MPa and the elongation to break was 10%.

The thickness of the ABAB layered fabric was modified by reducing the pressure or the nozzle aperture of the spray gun, between 0.15 to 0.5 mm without affecting the tensile strength of the fabric. Strength could be increased or reduced by modifying the order of layers, since the lower layer facing the model gives a smooth surface and the upper layer gives a rougher appearance.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A garment comprising a seamless wearable structure, wherein said structure has at least one tubular portion and at least three body-part openings.

2-5. (canceled)

6. The garment of claim 1, being said single seamless wearable structure.

7. The garment of claim 1, wherein said structure comprises at least one structural feature selected from the group consisting of appendix mounting, pattern, hole, eyelet, slit, mesh, net, thickening, bulge, protrusion, pleats, ribs, fold, crease, ridge, latch, loop, strap and any combination thereof.

8. The garment of claim 7, wherein said appendix is selected from the group consisting of a pocket panel, a button, a zipper, a collar, a cufflink, a belt, a buckle, a hood, a glove, a sleeve and another garment.

9. The garment of claim 8, wherein said appendix is integrally formed with said structure.

10. The garment of claim 8, wherein said appendix is attached to said structure.

11-13. (canceled)

14. The garment of claim 1, wherein said structure comprises a plurality of structural regions, each of said structural regions is individually characterized by a thickness that ranges from 0.1 to 10 mm.

15. The garment of claim 1, wherein said structure comprises a plurality of structural regions, each of said structural regions is individually characterized by a mass per unit area that ranges from 50 to 400 grams per square meter.

16. The garment of claim 1, wherein said structure comprises at least two types of materials.

17. The garment of claim 1, wherein said structure comprises a plurality of materials being distributed in a predetermined arrangement of portions of said structure, said portions merge into one-another in a seamless interface.

18. The garment of claim 16, wherein said structure or any portion thereof, is individually characterized by at least one of:
a breathability level that ranges from 0 Ret to 20 Ret according to standard ISO 11092 (the Ret or Hohenstein test);
a drape coefficient that ranges from 10% to 80% according to Cusick drape test;
a stretch and recovery level at 2 kg that ranges from 4% to 400% according to standard ASTM D 3107;
a dimensional stability to laundering after 3 washes lower than 5% according to standard AATCC 135;
a tensile strength of at least 10 kg according to standard ASTM D 5034;
a tearing strength of at least 1 kg according to standard ASTM D 1424;
an abrasion flex of no rupture or damage for at least 1000 cycles according to standard ASTM D 3885;
an abrasion resistance of no rupture to at least 10,000 cycles according to standard ASTM D 4966;
a water absorbency under 5 seconds according to AATCC/ASTM TS-018; and
a wrinkle recovery/resistance better than 2 on a scale of 1-5 according to AATCC 128/143.

19. (canceled)

20. The garment of claim 1, wherein said structure is multi-layered structure.

21. The garment of claim 20, wherein said multi-layered structure comprises layers of different materials or identical materials in any strata order.

22. The garment of claim 1, wherein said structure is formed by mold casting, mold injection, spinning, dipping, spraying, painting and brushing.

23. The garment of claim 1, wherein said structure is not a woven fabric.

24. (canceled)

25. A method of manufacturing the garment of claim 1, comprising forming said seamless wearable structure by a process selected from the group consisting of mold casting, mold injection, spinning, dipping, spraying, painting and brushing.

26. The method of claim 25, further comprising, after said forming, attaching an appendix to said structure.

27. A mold for manufacturing the garment of claim 1, comprising at least one mold cavity in the shape of said structure and at least one sprue.

28. The mold of claim 27, having at least one molding feature in said cavity for forming at least one structural feature in or on said structure.

29. The mold of claim 28, wherein said molding feature is for forming a structural feature selected from the group consisting of appendix mounting, pleat, pattern, hole, eyelet, slit, mesh, net, thickening, bulge, protrusion, pleats, ribs, fold, crease, ridge, latch, loop, strap and any combination thereof.

30. The mold of claim 27, having a plurality of sprues distributed in the mold for feeding a predetermined arrangement of portions of said cavity.

31. The mold of claim 30, wherein each of said plurality of sprues is configured individually for delivering a different and/or an identical liquid or powdered material precursor to form a predetermined arrangement of portions of said structure.
